(19) United States
(12) Patent Application Publication
(10) Pub. No.: US 2025/0208337 A1
(43) Pub. Date: Jun. 26, 2025

(54) NON-SURROUNDING SELECTIVE NUMERICAL APERTURE CLADDING LIGHT STRIPPER

(71) Applicant: Lumentum Operations LLC, San Jose, CA (US)

(72) Inventors: Jeff GREGG, San Jose, CA (US); Richard D. FAULHABER, San Carlos, CA (US); Kyle R. SCHNEIDER, Milpitas, CA (US)

(21) Appl. No.: 18/754,723

(22) Filed: Jun. 26, 2024

Related U.S. Application Data
(60) Provisional application No. 63/613,589, filed on Dec. 21, 2023.

(51) Int. Cl. G02B 6/02

(52) U.S. Cl. CPC G02B 6/02

(57) ABSTRACT

A cladding light stripper includes a light removal component. The light removal component is configured to contact a first circumferential region of an exterior surface of an exterior cladding of an optical fiber, wherein a coating covers a second circumferential region of the exterior surface of the exterior cladding of the optical fiber and does not cover the first circumferential region. The light removal component comprises a material that has an index of refraction that is greater than or equal to an index of refraction of the exterior cladding of the optical fiber. The light removal component has a shape that enables the light removal component to be disposed, when in contact with the first circumferential region of the exterior surface of the exterior cladding, over a partial circumference of the first circumferential region of the exterior surface of the exterior cladding.

### CROSS-REFERENCE TO RELATED APPLICATION

This Patent Application claims priority to U.S. Patent Application No. 63/613,589, filed on Dec. 21, 2023, and entitled “SELECTIVE NUMERICAL APERTURE CLADDING LIGHT STRIPPER.” The disclosure of the prior Application is considered part of and is incorporated by reference into this Patent Application.

### TECHNICAL FIELD

The present disclosure relates generally to a cladding light stripper and more specifically to a non-surrounding selective numerical aperture cladding light stripper.

### BACKGROUND

An optical fiber can include a core, which carries light, and a cladding, which surrounds the core and is configured to confine the light within the core. A cladding light stripper is used to remove or extract light that is in the cladding of the optical fiber.

### SUMMARY

In some implementations, a cladding light stripper includes a light removal component, wherein: the light removal component is configured to contact a first circumferential region of an exterior surface of an exterior cladding of an optical fiber, wherein a coating covers a second circumferential region of the exterior surface of the exterior cladding of the optical fiber and does not cover the first circumferential region; the light removal component comprises a material that has an index of refraction that is greater than or equal to an index of refraction of the exterior cladding of the optical fiber; and the light removal component has a shape that enables the light removal component to be disposed, when in contact with the first circumferential region of the exterior surface of the exterior cladding, over a partial circumference of the first circumferential region of the exterior surface of the exterior cladding.

In some implementations, a cladding light stripper includes one or more light removal components, wherein: a light removal component, of the one or more light removal components, is configured to contact a circumferential region of an exterior surface of an exterior cladding of an optical fiber; the light removal component comprises a material that has an index of refraction that is greater than or equal to an index of refraction of the exterior cladding of the optical fiber; and the light removal component is configured to be disposed, when in contact with the circumferential region of the exterior surface of the exterior cladding, over a partial circumference of the circumferential region of the exterior surface of the exterior cladding.

In some implementations, a cladding light stripper includes a light removal component, wherein: the light removal component is configured to contact a circumferential region of an exterior surface of an exterior cladding of each optical fiber of a plurality of optical fibers; the light removal component comprises a material that has an index of refraction that is greater than or equal to an index of refraction of the exterior cladding of each optical fiber; and the light removal component is configured to be disposed, when in contact with the circumferential region of the exterior surface of the exterior cladding of each optical fiber, over a partial circumference of the circumferential region of the exterior surface of the exterior cladding of each optical fiber.

### BRIEF DESCRIPTION OF THE DRAWINGS

FIGS. 1A-1C are diagrams of example implementations described herein.

FIGS. 2A-2C are diagrams of example implementations described herein.

FIGS. 3A-3C are diagrams of example implementations described herein.

FIG. 4 shows an example plot associated with an example implementation described herein.

FIG. 5 shows an example plot associated with an example implementation described herein.

### DETAILED DESCRIPTION

The following detailed description of example implementations refers to the accompanying drawings. The same reference numbers in different drawings may identify the same or similar elements.

In many cases, such as for high-power (e.g., kilowatt class, or greater) applications, a laser can include an optical fiber that includes a polymeric coating (e.g., that circumferentially surrounds a cladding of the optical fiber). The polymeric coating can have a low refractive index to guide light (e.g., cladding light) within the cladding of the optical fiber (e.g., in addition to core light that propagates within a core of the optical fiber). Because of a low melting point, the polymeric coating is often considered to be a weak point in the construction and operation of high-power lasers. For example, a packing process to form a high-power laser can cause an optical fiber to be manipulated (e.g., bent or twisted) such that high-power light that propagates via the optical fiber then leaks out of a cladding of the optical fiber in an uncontrolled manner. This leaked high-power light then overheats the polymeric coating of the optical fiber, which degrades a performance of the optical fiber (and the high-power laser that includes the optical fiber), and leads to failure of the optical fiber (and the high-power laser). Consequently, there is a need to mitigate and/or manage leaked cladding light from an optical fiber, especially for high-power applications.

A cladding light stripper can remove excess and/or unwanted cladding light (e.g., that leaks from a cladding of an optical fiber) in a controlled manner. For example, a cladding light stripper can be formed by patterning or etching the bare glass of a cladding of an optical fiber (e.g., creating an uneven cladding surface), or recoating the optical fiber with a polymer, a ceramic, or glass. When forming a cladding light stripper, it is often desirable to target and remove a particular portion of light that propagates via an optical fiber (e.g., that would otherwise leak from a cladding of the optical fiber). However, limitations on current cladding light stripper formation techniques and available materials (e.g., due to discrete numerical apertures (NAs) of the materials) for forming cladding light strippers often allow too much or too little light to be removed from the optical fiber. In particular, cladding light strippers cannot be reliably formed to remove cladding light that is associated with NAs that are greater than a particular NA (e.g., a selected NA).

As used herein, a component (or a material of the component) may be described as “having an NA” or “with an NA.” This refers to a property of an interface between the component and another component (e.g., comprising another material) (or air), and is based on respective refractive indices of the component and the other component (or air). The NA of the component characterizes a range of angles over which the interface reflects or transmits light. In a specific example, for fiber optics, an NA of an optical fiber describes a range of angles within which light incident within the optical fiber is transmitted along the optical fiber (e.g., within the optical fiber), instead of leaking out of the optical fiber. When a component is described as having an X NA, the maximum NA that the component can support is X (e.g., to allow total internal reflection within the component). Additionally, as used herein, light (e.g., cladding light) may be described as “having an NA,” which characterizes a range of angles at which the light propagates (e.g., through an optical fiber). When light is described as having a Y NA, the maximum NA of the light is Y.

Some implementations described herein include a non-surrounding selective NA cladding light stripper. The non-surrounding selective NA cladding light stripper is configured to selectively target only higher order, higher NA, evanescent components of multimode laser light in an optical fiber to reduce heating effects (e.g., due to packaging of fiber components within the optical fiber) on a coating (e.g., a polymeric coating) of the optical fiber. The non-surrounding selective NA cladding light stripper may include, for example, a light removal component (e.g., a quartz block) that is configured to strip only a “high NA” portion of cladding light from the optical fiber (and to reflect a “low NA” portion of the cladding light).

The light removal component is configured to contact a first circumferential region of an exterior surface of an exterior cladding of the optical fiber (e.g., that is not covered by the coating of the optical fiber). The light removal component comprises a material that has an index of refraction that is greater than or equal to an index of refraction of the exterior cladding of the optical fiber. Further, the light removal component has a shape that enables the light removal component to be disposed, when in contact with the first circumferential region of the exterior surface of the exterior cladding, over a partial circumference of the first circumferential region of the exterior surface of the exterior cladding. That is, the light removal component does not surround the exterior surface of the exterior cladding. In this way, by combining a “high” refractive index of the light removal component and selective manipulation of a contact surface area of the light removal component with the exterior surface of the exterior cladding, a portion of cladding light (e.g., a “high NA” portion that is associated with one or more NAs that are greater than a maximum selected NA) may be removed by the light removal component from the optical fiber.

In this way, some implementations allow for selective stripping of a specific range of NAs of unwanted cladding light from the optical fiber. When used in a high-power application, this reduces a likelihood that high-power cladding light leaks (e.g., in a region associated with a splice point or other point where high NA cladding light is likely to be present) and overheats the coating of the output fiber. This therefore improves a performance of the optical output fiber, and reduces a likelihood of failure of the output fiber. Further, this thereby improves a performance of a laser system that includes the cladding light stripper and the output fiber, and reduces a likelihood of failure of the laser system.

Moreover, because the light removal component is configured to be disposed over a partial circumference of the region of the exterior surface of the exterior cladding of the optical fiber (rather than an entire circumference of the region) (e.g., the cladding light stripper is a non-surrounding cladding light stripper), the cladding light stripper described herein provides flexibility and adaptability within an optical system. For example, the cladding light stripper can be attached to an optical fiber when needed, moved to another region along the optical fiber (e.g., to ensure an optimal position of the cladding light stripper or the optical fiber with respect to other components of the optical system), and/or can be removed from the optical fiber and attached to a different optical fiber (e.g., due to changing optical system requirements), among other examples. This is in contrast to typical cladding light strippers that are associated with a particular region of an optical fiber (e.g. an exterior cladding of the particular region is etched, or the optical fiber is formed to insert into a circumferential, entirely surrounding or encircling component that is to align with the particular region of the optical fiber, among other examples). Accordingly, the cladding light stripper described herein enables efficient customization within an optical system, which is not practically available using other cladding light strippers.

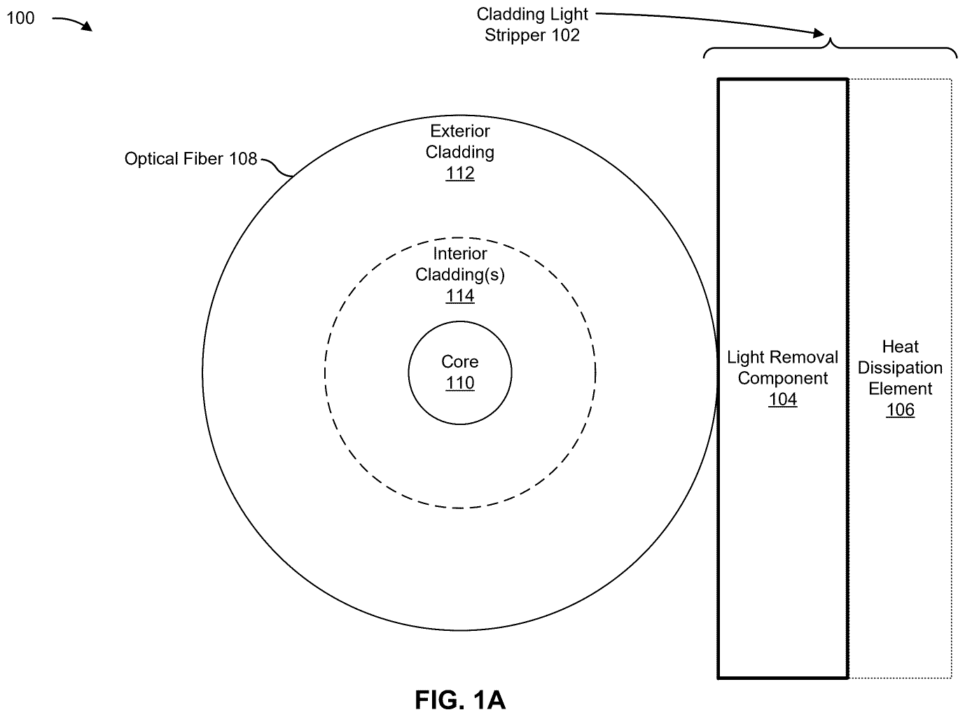

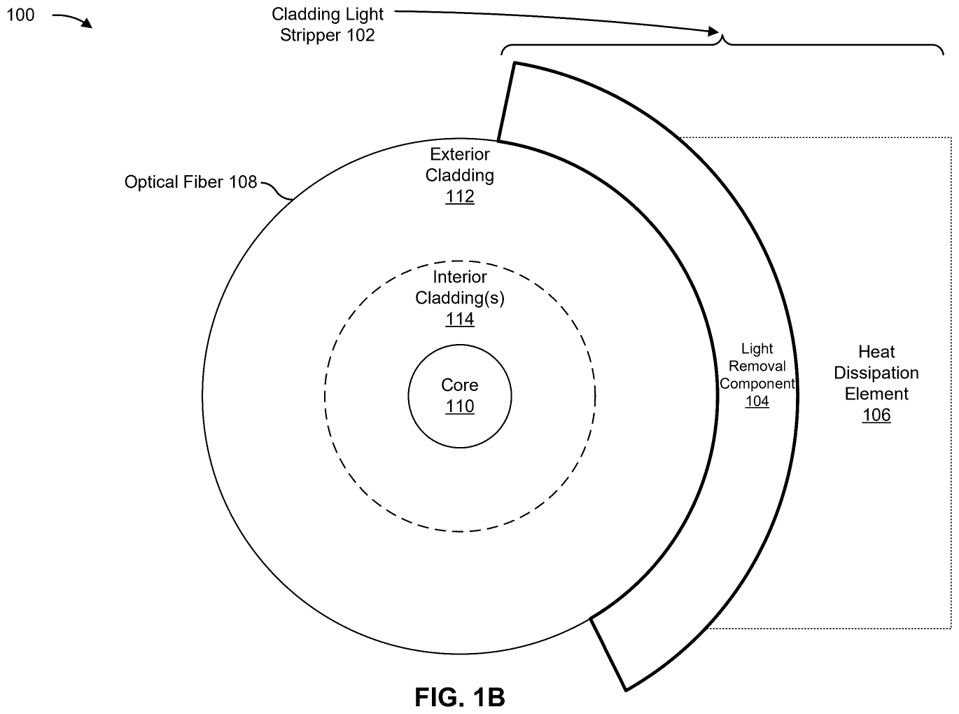

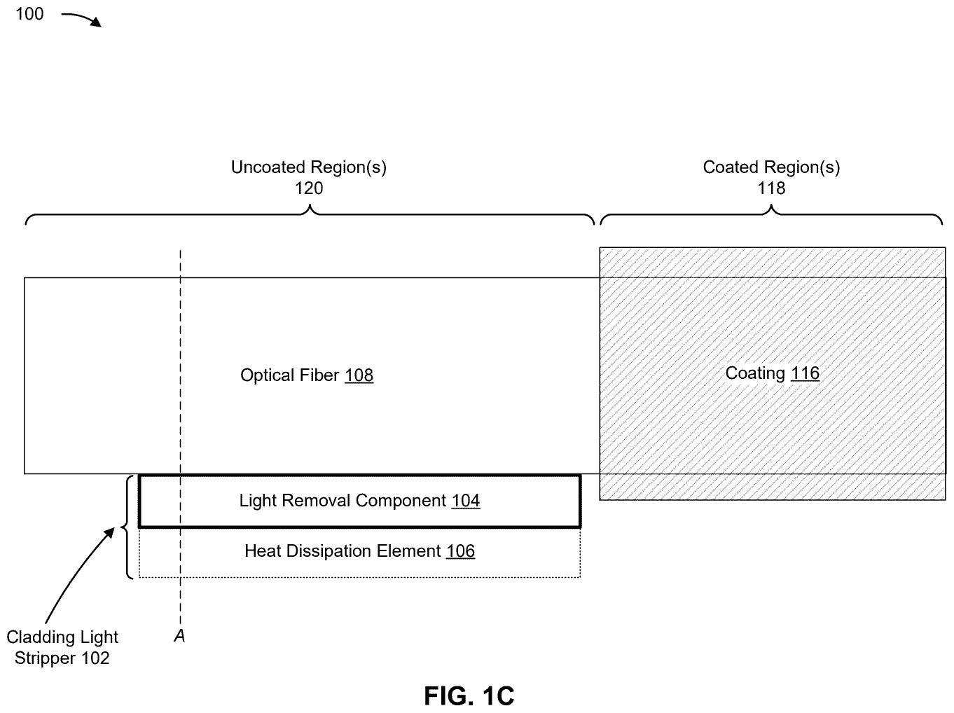

FIGS. 1A-1C are diagrams of example implementations 100 described herein. As shown in FIGS. 1A-1C, the example implementations 100 include a cladding light stripper 102. The cladding light stripper 102 may include a light removal component 104 and, optionally, a heat dissipation element 106. As further shown in FIGS. 1A-1C, the example implementation may include an optical fiber 108 that includes a core 110, an exterior cladding 112, and, optionally, one or more interior claddings 114.

FIGS. 1A-1B show cross-sectional views of the optical fiber 108 (e.g., along the line A shown in FIG. 1C), where different configurations of the cladding light stripper 102 contact the optical fiber 108. The optical fiber 108 may be configured to transmit a high power optical beam (e.g. more than 200 W, more than 1 kW, more than 10 KW), such as for material processing and/or an industrial purpose. In some implementations, the optical fiber 108 may be included in an optical system or an optical device. For example, the optical fiber 108 may be an input fiber or an output fiber of a pump combiner, a signal-pump combiner, an optical amplifier, or an optical coupler, among other examples.

As shown in FIG. 1A, the optical fiber 108 may include the core 110 and the exterior cladding 112. In some implementations, the optical fiber 108 may also include the one or more interior claddings 114. As further shown in FIG. 1A, the exterior cladding 112 may surround (e.g., circumferentially surround) the core 110. In some implementations, when the optical fiber 108 includes the one or more interior claddings 114, the exterior cladding 112 may surround the one or more interior claddings 114, and the one or more interior claddings 114 may surround the core 110. Accordingly, the exterior cladding 112 may surround the one or more interior claddings 114 and the core 110.

In some implementations, the optical fiber 108 may be configured to propagate core light (e.g., from an input end of the optical fiber 108 to an output end of the optical fiber 108). For example, the core 110 may be configured to propagate the core light (e.g., within the core 110). The one or more interior claddings 114 and/or the exterior cladding 112 may be configured to confine the core light within the core 110 (e.g., confine the light inward, such as from an inner diameter of an interior cladding 114 of the one or more interior claddings 114, and/or an inner diameter of the exterior cladding 112). The core light may be provided by a core light source (e.g., a laser light source, or another type of light source, not shown in FIGS. 1A-1C).

Additionally, or alternatively, the optical fiber 108 may be configured to propagate cladding light (e.g., from the input end of the optical fiber 108 to the output end of the optical fiber 108). For example, the exterior cladding 112 may be configured to propagate the cladding light (e.g., within the exterior cladding 112). The one or more interior claddings 114 and/or the core 110 may be configured to confine the cladding light within the exterior cladding (e.g., confine the light outward, such as from an outer diameter of an interior cladding 114 of the one or more interior claddings 114, and/or an outer diameter of the core 110). The cladding light may be provided by a cladding light source (e.g., a laser light source, or another type of light source, not shown in FIGS. 1A-1C), or may be “leaked” core light from the core 110 (e.g., core light that did not couple into the core 110 and/or propagated out of the core 110). In some implementations, the one or more interior claddings 114 may be configured to additionally propagate the cladding light (e.g., in addition to the exterior cladding 112), or may be configured to propagate additional cladding light (e.g., that is different than the cladding light).

In some implementations, the optical fiber 108 may comprise glass (e.g., a silica-based glass, a quartz-based glass, a doped glass, or another type of glass). In some implementations, the core 110, the exterior cladding 112, and/or the one or more interior claddings 114 may comprise a same type of glass, such as a silica-based glass. Alternatively, the core 110, the exterior cladding 112, and/or the one or more interior claddings 114 may comprise different types of glass. For example, the core 110 may comprise a doped silica-based glass (e.g., doped with germanium, fluorine, or another dopant) and each of the exterior cladding 112 and/or the one or more interior claddings 114 may comprise an undoped silica-based glass (or vice versa).

As shown in FIG. 1C, the optical fiber 108 may include a coating 116 (sometimes referred to as a buffer or jacket) that covers one or more regions (e.g., one or more circumferential regions) of the optical fiber 108. That is, the coating 116 may cover one or more regions (herein after referred to as one or more coated regions 118) of an exterior surface of the exterior cladding 112 of the optical fiber 108. Further, one or more other regions (e.g., one or more other circumferential regions) of the optical fiber 108, which do not overlap with the one or more coated regions 118, may not be covered by the coating 116. That is, the coating 116 may not cover one or more other regions (herein after referred to as one or more uncoated regions 120) of the exterior surface of the exterior cladding 112 of the optical fiber 108. The coating 116 may comprise a polymeric material, such as a material that includes at least one of polyimide (PI), polyvinyl chloride (PVC), polyethylene (PE), polyurethane (PU), or nylon. In some implementations, the coating 116 may be located on the optical 108 fiber adjacent to but after the cladding light stripper 102, that is to say, a light beam passing through the optical fiber 108 would pass the cladding light stripper 102 before the coating 116 so that cladding light could be stripped from the optical fiber 108 before it could damage the coating 116. The greater the power of the light beam in the optical fiber 108, the greater the risk of damage to the coating 116.

The cladding light stripper 102 may be configured to contact the optical fiber 108. For example, as shown in FIG. 1A, the light removal component 104 of the cladding light stripper 102 may be configured to contact a region (e.g., a circumferential region) of an exterior surface of the exterior cladding 112 of the optical fiber 108 (e.g., a region that is not covered by the coating 116, such as an uncoated region 120). The region of the exterior surface of the exterior cladding 112 may be associated with (e.g., physically near) a splice of the optical fiber 108, a taper of the optical fiber 108, a bend of the optical fiber 108, or another section of the optical fiber 108 through which cladding light is likely to have “high NA” light (as further described herein).

In some implementations, the light removal component 104 may have a shape that enables the light removal component 104, when in contact with the region of the exterior surface of the exterior cladding 112, to be disposed over a partial circumference of the region of the exterior surface of the exterior cladding 112 (rather than an entire circumference of the region). That is, the light removal component 104 may not surround the region of the exterior surface of the exterior cladding 112. For example, as shown in FIG. 1A, the shape of the light removal component 104 may be planar, such that the light removal component 104 is configured to contact the region of the exterior surface of the exterior cladding 112 at a single point (e.g., when viewing a cross-section of the optical fiber 108). As another example, as shown in FIG. 1B, the shape of the light removal component 104 may be u-shaped, such that the light removal component 104 is configured to contact the region of the exterior surface of the exterior cladding 112 along a section (e.g., an arc) of a circumference of the region of the exterior surface of the exterior cladding 112. Accordingly, the light removal component 104 may be disposed over a partial circumference of the region of the exterior surface of the exterior cladding (rather than an entire circumference of the region) when the light removal component 104 contacts a single point of the region or when the light removal component 104 contacts a section (e.g., an arc) of a circumference of the region. In this way, the light removal component 104 enables the cladding light stripper 102 to be a non-surrounding selective NA cladding light stripper.

In some implementations, the light removal component 104 may comprise at least one of quartz, fused silica, or doped fused silica, among other examples. In some implementations, the light removal component 104 may comprise a material that has an index of refraction that is greater than or equal to an index of refraction of the exterior cladding 112. For example, when the exterior cladding 112 comprises a glass with an index of refraction of 1.45, the light removal component 104 may comprise quartz with an index of refraction of 1.456.

Accordingly, the exterior cladding 112 may be configured to propagate cladding light (e.g., as described above), wherein the cladding light has an NA distribution. In some implementations, a first portion of the cladding light may be associated with NAs that are greater than a maximum selected NA for the cladding light, and the light removal component 104 may be configured to remove greater than a first threshold percentage of the first portion of the cladding light (e.g., as the cladding light propagates through a section of the exterior cladding 112 that is associated with the region of the exterior surface of the exterior cladding 112). The first threshold percentage may be, for example, greater than or equal to 99%, 99.5%, 99.6%, 99.7%, 99.8%, or 99.9%. Moreover, a second portion of the cladding light may be associated with NAs that are less than or equal to the maximum selected NA for the cladding, and the light removal component 104 may be configured to remove less than a second threshold percentage of the second portion of the cladding light (e.g., as the cladding light propagates through a section of the exterior cladding 112 that is associated with the region of the exterior surface of the exterior cladding 112). The second threshold percentage may be, for example, less than or equal to 0.1%, 0.2%, 0.3%, 0.4%, 0.5%, or 1%. In this way, the light removal component 104 may be configured to “strip” a “high NA portion” of the cladding light (e.g., the first portion of the cladding light), and to “keep” a “low NA” portion of the cladding light (e.g., the second portion of the cladding light).

Notably, a shape of the light removal component 104 may be selected or determined to ensure that the light removal component 104 removes greater than the first threshold percentage of the first portion of the cladding light and/or remove less than the second threshold percentage of the second portion of the cladding light. That is, the light removal component 104 may be designed such that the light removal component 104 contacts a particular amount (e.g. as a point or an arc) of the circumference of the region of the exterior surface of the exterior cladding to enable the light removal component 104 removing greater than the first threshold percentage of the first portion of the cladding light and/or removing less than the second threshold percentage of the second portion of the cladding light.

As shown in FIGS. 1A-1B, the heat dissipation element 106 may be disposed on the light removal component 104 (e.g., a surface of the light removal component 104 that is not in contact with the exterior cladding 112 of the optical fiber 108). The heat dissipation element 106 may be a heat sink (e.g., a passive heat sink or an active heat sink), or another type of cooling element, that is configured to thermally conduct heat associated with the stripped high NA portion of the cladding light away from the optical fiber 108. In this way, the heat dissipation element 106 may prevent, or reduce a likelihood of, thermal damage to the optical fiber 108.

FIGS. 1A-1C are provided as an example. Other examples may differ from what is described with regard to FIGS. 1A-1C.

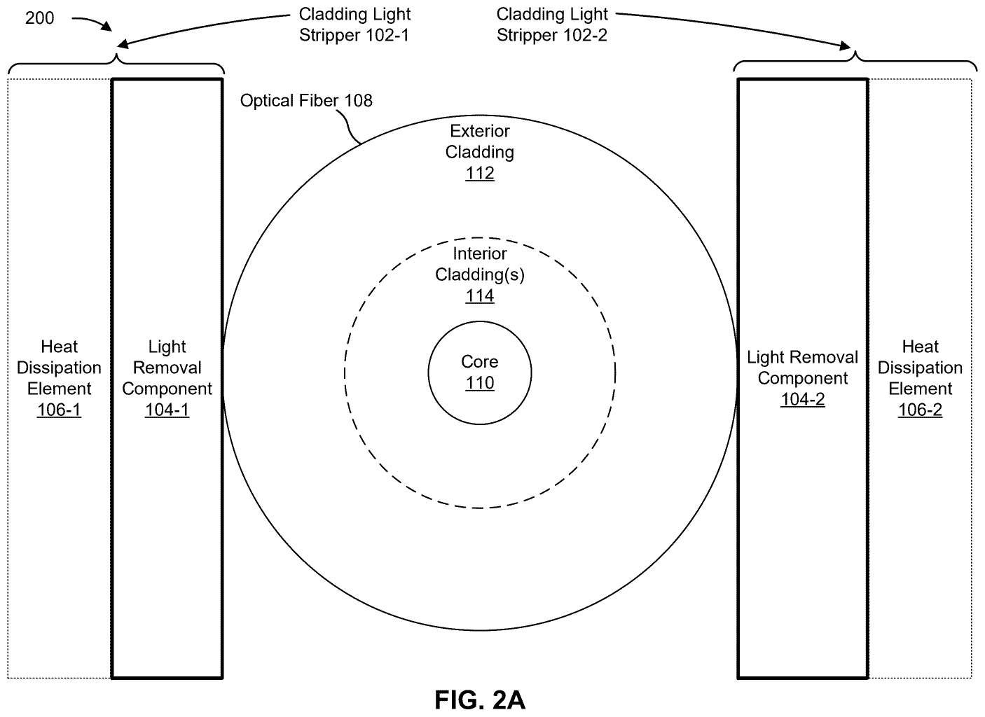

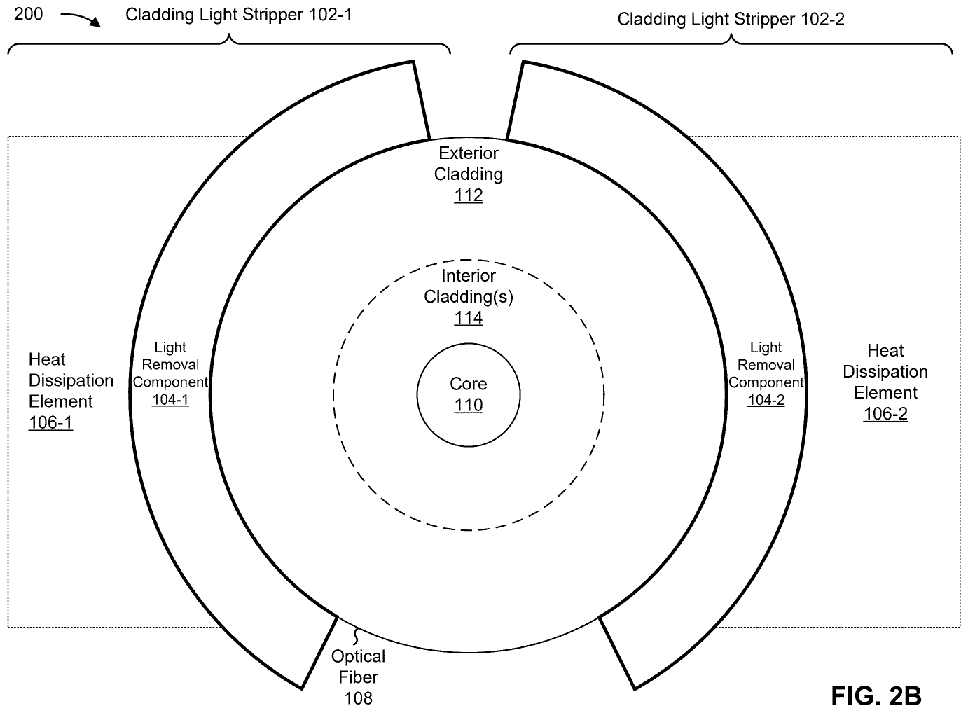

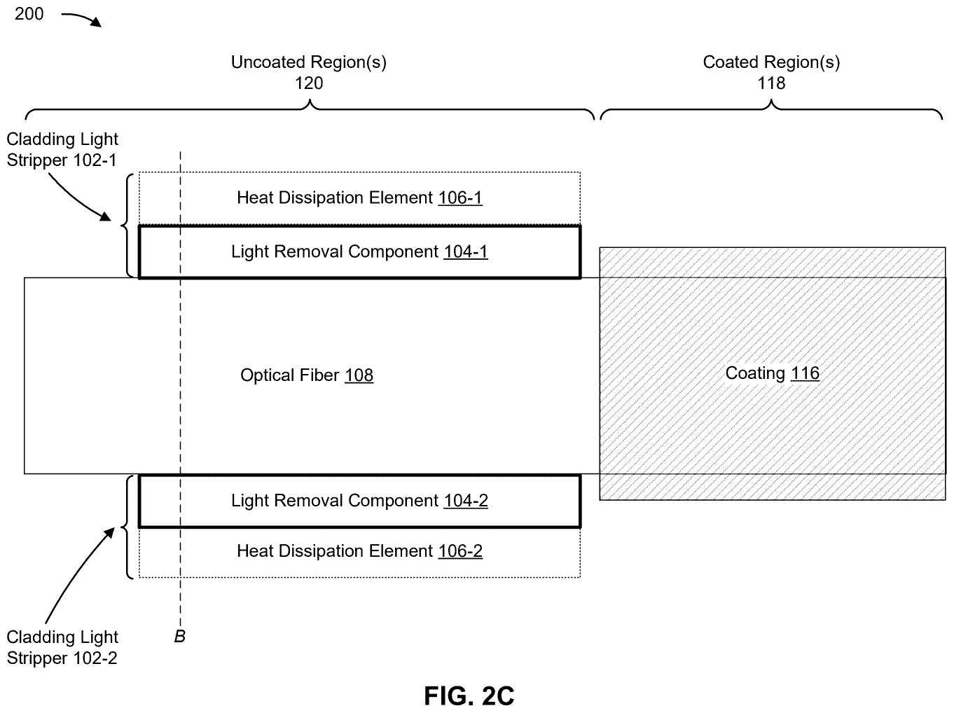

FIGS. 2A-2C are diagrams of example implementations 200 described herein. As shown in FIGS. 2A-2C, the example implementations 200 includes a plurality of cladding light strippers 102 (shown as a first cladding light stripper 102-1 and a second cladding light stripper 102-2) and the optical fiber 108. FIGS. 2A-2B show cross-sectional views of the optical fiber 108 (e.g., along the line B shown in FIG. 2C), where different configurations of the plurality of cladding light strippers 102 contact the optical fiber 108.

The optical fiber 108 may be configured in a same, or similar, manner as that described herein in relation to FIGS. 1A-1C. For example, the optical fiber 108 may include the core 110 and the exterior cladding 112, and optionally the one or more interior claddings 114. The optical fiber 108 may be configured to propagate core light, such as via the core 110, and/or to propagate cladding light, such as via the exterior cladding 112. The optical fiber may include the coating 116 that covers one or more coated regions 118 of the exterior surface of the exterior cladding 112. Further, the coating 116 may not cover one or more uncoated regions 120 of the exterior surface of the exterior cladding 112.

Each cladding light stripper 102, of the plurality of cladding light strippers 102, may be configured in a same, or similar, manner as that described herein in relation to FIGS. 1A-1C. For example, each cladding light stripper 102 may be configured to contact the optical fiber 108 before the coating 116 to remove high NA light from within the optical fiber 108 which could otherwise heat and damage the coating 116. For example, each cladding light stripper 102 may include the light removal component 104 and, optionally, the heat dissipation element 106 (e.g., the first cladding light stripper 102-1 may include a first light removal component 104-1 and, optionally, a first heat dissipation element 106-1; and the second cladding light stripper 102-2 may include a second light removal component 104-2 and, optionally, a second heat dissipation element 106-2).

Each cladding light stripper 102 may be configured to contact the optical fiber 108. For example, the first light removal component 104-1 of the first cladding light stripper 102-1 may be configured to contact a first portion of a region (e.g., a circumferential region) of the exterior surface of the exterior cladding 112 of the optical fiber 108 (e.g., a region that is not covered by the coating 116, such as an uncoated region 120), and the second light removal component 104-2 of the second cladding light stripper 102-2 may be configured to contact a second portion of the region of the exterior surface of the exterior cladding 112 of the optical fiber 108. The first portion of the region of the exterior surface of the exterior cladding 112 of the optical fiber 108 and the second portion of the region of the exterior surface of the exterior cladding 112 of the optical fiber 108 may overlap (e.g., may intersect a same circumferential line of the exterior surface of the exterior cladding 112), or, alternatively, may not overlap (e.g., may not intersect any same circumferential line of the exterior surface of the exterior cladding 112). That is the, the first light removal component 104-1 and the second light removal component 104-2 may each be located at different points along a same portion of the region of the exterior surface of the exterior cladding 112 of the optical fiber 108, or, alternatively, may be distributed at different portions of the region of the exterior surface of the exterior cladding 112 of the optical fiber 108.

Each light removal component 104, of the plurality of cladding light strippers 102, may have a shape that enables the light removal component 104, when in contact with the region of the exterior surface of the exterior cladding 112, to be disposed over a partial circumference of the region of the exterior surface of the exterior cladding 112 (rather than an entire circumference of the region), such as in a same, or similar, manner as that described herein in relation to FIGS. 1A-1C. That is, each light removal component 104 may not surround the region of the exterior surface of the exterior cladding 112. For example, as shown in FIG. 2A, the shape of each light removal component 104 may be planar, such that the light removal component 104 is configured to contact the region of the exterior surface of the exterior cladding 112 at a single point (e.g., when viewing a cross-section of the optical fiber 108). As another example, as shown in FIG. 2B, the shape of each light removal component 104 may be u-shaped, such that the light removal component 104 is configured to contact the region of the exterior surface of the exterior cladding 112 along a section (e.g., an arc) of a circumference of the region of the exterior surface of the exterior cladding 112. Accordingly, each light removal component 104 may be disposed over a partial circumference of the region of the exterior surface of the exterior cladding (rather than an entire circumference of the region) when the light removal component 104 contacts a single point of the region or when the light removal component 104 contacts a section (e.g., an arc) of a circumference of the region. Further, each light removal component 104 may comprise a material that has an index of refraction that is greater than or equal to an index of refraction of the exterior cladding 112.

Accordingly, the exterior cladding 112 may be configured to propagate cladding light (e.g., as described above), wherein the cladding light has an NA distribution. In some implementations, a first portion of the cladding light may be associated with NAs that are greater than a maximum selected NA for the cladding light, and a particular light removal component 104 (e.g., of the first light removal component 104-1 and the second light removal component 104-2) may be configured to remove greater than the first threshold percentage of the first portion of the cladding light (e.g., as the cladding light propagates through a section of the exterior cladding 112 that is associated with the region of the exterior surface of the exterior cladding 112), as described above. Moreover, a second portion of the cladding light may be associated with NAs that are less than or equal to the maximum selected NA for the cladding light, and the particular light removal component 104 may be configured to remove less than the second threshold percentage of the second portion of the cladding light (e.g., as the cladding light propagates through a section of the exterior cladding 112 that is associated with the region of the exterior surface of the exterior cladding 112), as described above. In this way, the particular light removal component 104 may be configured to strip a high NA portion of the cladding light (e.g., the first portion of the cladding light), and to keep a low NA portion of the cladding light (e.g., the second portion of the cladding light). In some implementations, the plurality of light removal components 104 may be configured to, as a group (e.g., collectively), strip the high NA portion of the cladding light (e.g., the first portion of the cladding light), and to keep the low NA portion of the cladding light (e.g., the second portion of the cladding light).

As shown in FIGS. 2A-2C, each heat dissipation element 106 may be disposed on a corresponding light removal component 104 (e.g., a surface of the light removal component 104 that is not in contact with the exterior cladding 112 of the optical fiber 108). Each heat dissipation element 106 may be a heat sink (e.g., a passive heat sink or an active heat sink), or another type of cooling element, that is configured to thermally conduct heat associated with the stripped high NA portion of the cladding light away from the optical fiber 108. In this way, each heat dissipation element 106 may prevent, or reduce a likelihood of, thermal damage to the optical fiber 108.

FIGS. 2A-2C are provided as an example. Other examples may differ from what is described with regard to FIGS. 2A-2C.

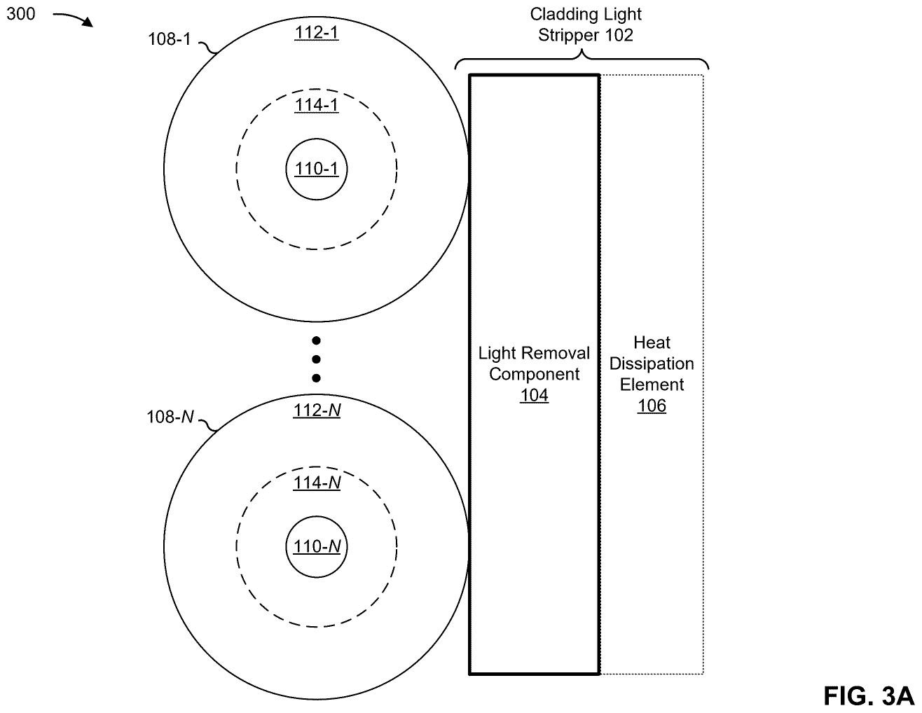

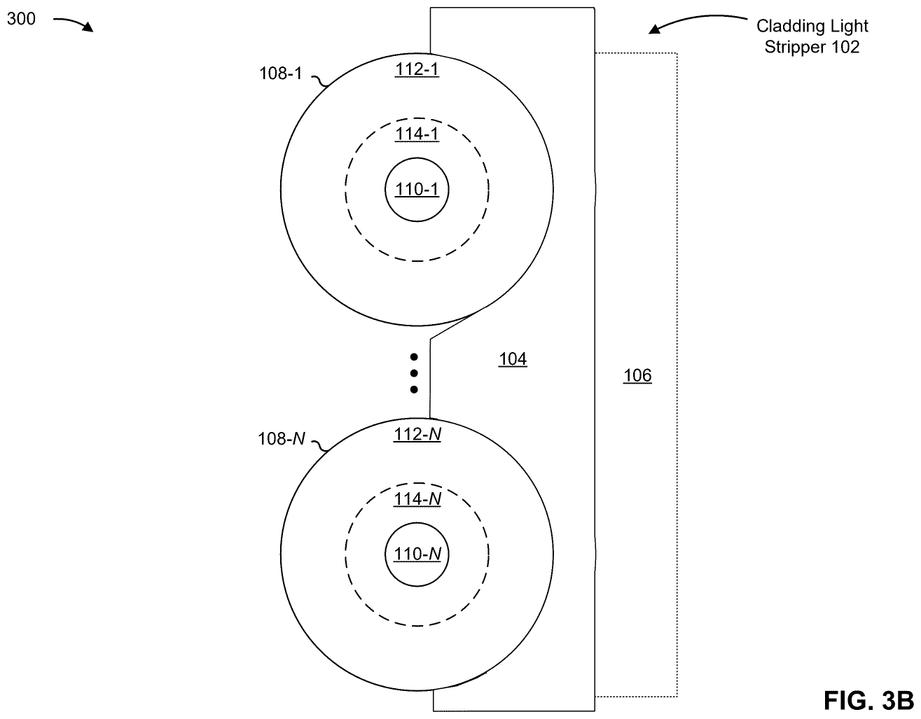

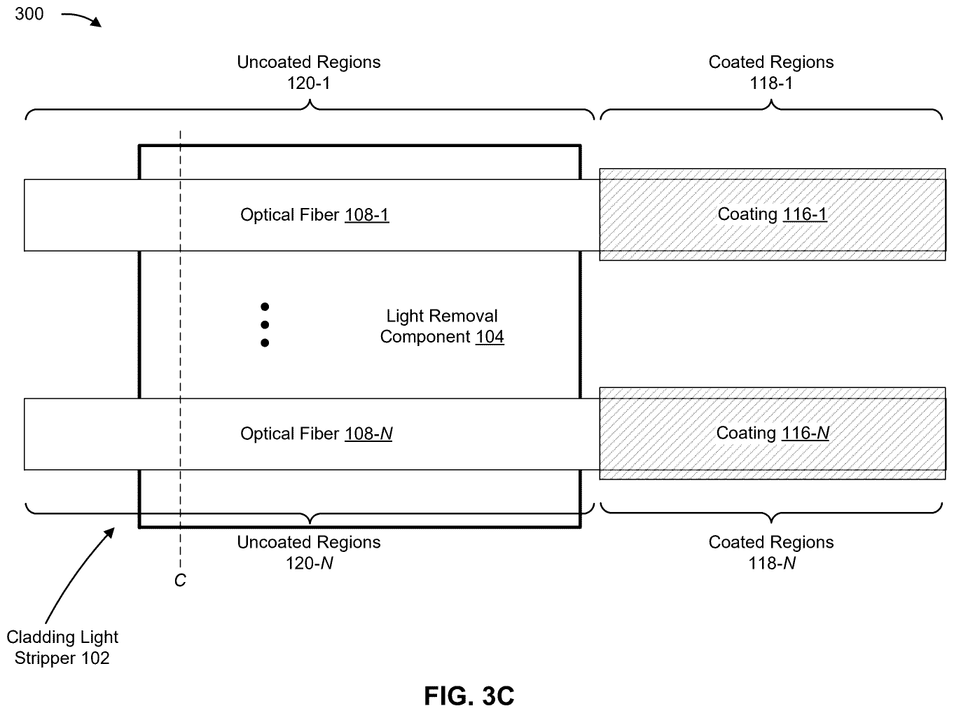

FIGS. 3A-3C are diagrams of example implementations 300 described herein. As shown in FIGS. 3A-3C, the example implementations 300 include a cladding light stripper 102 and a plurality of optical fibers 108 (shown as optical fibers 108-1 through 108-N). FIGS. 3A-3B show cross-sectional views of the plurality of optical fibers 108 (e.g., along the line C shown in FIG. 3C), where different configurations of the cladding light stripper 102 contact the plurality of optical fibers 108.

Each optical fiber 108, of the plurality of optical fibers 108, may be configured in a same, or similar, manner as that described herein in relation to FIGS. 1A-1C. For example, each optical fiber 108 may include the core 110 and the exterior cladding 112, and optionally the one or more interior claddings 114 (e.g., the optical fiber 108-1 may include a core 110-1, an exterior cladding 112-1, and, optionally, one or more interior claddings 114-1; and the optical fiber 108-N may include a core 110-N, an exterior cladding 112-N, and, optionally, one or more interior claddings 114-N). Each optical fiber 108 may be configured to propagate core light, such as via the core 110, and/or to propagate cladding light, such as via the exterior cladding 112. Each optical fiber may include the coating 116 that covers one or more coated regions 118 of the exterior surface of the exterior cladding 112 (e.g., the optical fiber 108-1 may include a coating 116-1 that covers one or more coated regions 118-1; and the optical fiber 108-N may include a coating 116-N that covers one or more coated regions 118-N). Further, the coating 116 may not cover one or more uncoated regions 120 of the exterior surface of the exterior cladding 112 (e.g., the coating 116-1 may not cover one or more uncoated regions 120-1, and the coating 116-N may not cover one or more uncoated regions 120-N).

The cladding light stripper 102 may be configured in a same, or similar, manner as that described herein in relation to FIGS. 1A-1C. For example, the cladding light stripper 102 may include the light removal component 104 and, optionally, the heat dissipation element 106. The cladding light stripper 102 may be configured to contact each optical fiber 108 of the plurality of optical fibers 108. For example, the light removal component 104 may be configured to contact a region (e.g., a circumferential region) of the exterior surface of the exterior cladding 112 of each optical fiber 108 (e.g., a region that is not covered by the coating 116, such as an uncoated region 120).

The light removal component 104 may configured to be disposed, when in contact with the region of the exterior surface of the exterior cladding 112 of each optical fiber 108, over a partial circumference of the region of the exterior surface of the exterior cladding 112 of each optical fiber 108 (rather than an entire circumference of the region), such as in a same, or similar, manner as that described herein in relation to FIGS. 1A-1C. That is, the light removal component 104 may not surround the region of the exterior surface of the exterior cladding 112. For example, as shown in FIG. 3A, respective portions of the light removal component 104 may be associated with the plurality of optical fibers 108, and a shape of each portion of the light removal component 104 is planar, such that the light removal component 104 is configured to contact the region of the exterior surface of each exterior cladding 112 at a single point (e.g., when viewing a cross-section of the plurality of optical fibers 108). As another example, as shown in FIG. 3B, respective portions of the light removal component 104 may be associated with the plurality of optical fibers 108, and a shape of each portion of the light removal component 104 is u-shaped, such that the light removal component 104 is configured to contact the region of the exterior surface of each exterior cladding 112 along a section (e.g., an arc) of a circumference of the region of the exterior surface of each exterior cladding 112. Further, the light removal component 104 may comprise a material that has an index of refraction that is greater than or equal to an index of refraction of the exterior cladding 112 of each optical fiber 108. While FIG. 3C illustrates optical fibers 108-1 to 108-N oriented in the same direction of propagation on the cladding light stripper 102 with corresponding coatings 116-1 to 116-N located on the same side of the cladding light stripper 102, such a uni-directional configuration is optional. For example, some optical fibers (not illustrated) may have an opposite direction of propagation in which case, the associated coatings (not illustrated) would be downstream from the cladding light stripper 102 and therefore located on an opposite side of the cladding light stripper 102 from the coatings 116-1 to 116-N so illustrated. Thereby, the same light removal component 104 can be used for several different optical fibers which are not constrained to have a single common direction of propagation.

Accordingly, the exterior cladding 112 of each optical fiber 108 may be configured to propagate cladding light (e.g., as described above), wherein the cladding light has an NA distribution. In some implementations, a first portion of the cladding light may be associated with NAs that are greater than a maximum selected NA for the cladding light, and the light removal component 104 may be configured to remove greater than the first threshold percentage of the first portion of the cladding light (e.g., as the cladding light propagates through a section of the exterior cladding 112 that is associated with the region of the exterior surface of the exterior cladding 112), as described above. Moreover, a second portion of the cladding light may be associated with NAs that are less than or equal to the maximum selected NA for the cladding light, and the light removal component 104 may be configured to remove less than the second threshold percentage of the second portion of the cladding light (e.g., as the cladding light propagates through a section of the exterior cladding 112 that is associated with the region of the exterior surface of the exterior cladding 112), as described above. In this way, the particular light removal component 104 may be configured to strip a high NA portion of the cladding light (e.g., the first portion of the cladding light), and to keep a low NA portion of the cladding light (e.g., the second portion of the cladding light) within the exterior cladding 112 of each optical fiber 108.

As shown in FIGS. 3A-3B, the heat dissipation element 106 may be disposed on the light removal component 104 (e.g., a surface of the light removal component 104 that is not in contact with the exterior cladding 112 of each optical fiber 108). The heat dissipation element 106 may be a heat sink (e.g., a passive heat sink or an active heat sink), or another type of cooling element, that is configured to thermally conduct heat associated with the stripped high NA portion of the cladding light away from each optical fiber 108. In this way, the heat dissipation element 106 may prevent, or reduce a likelihood of, thermal damage to the plurality of optical fibers 108.

FIGS. 3A-3C are provided as an example. Other examples may differ from what is described with regard to FIGS. 3A-3C.

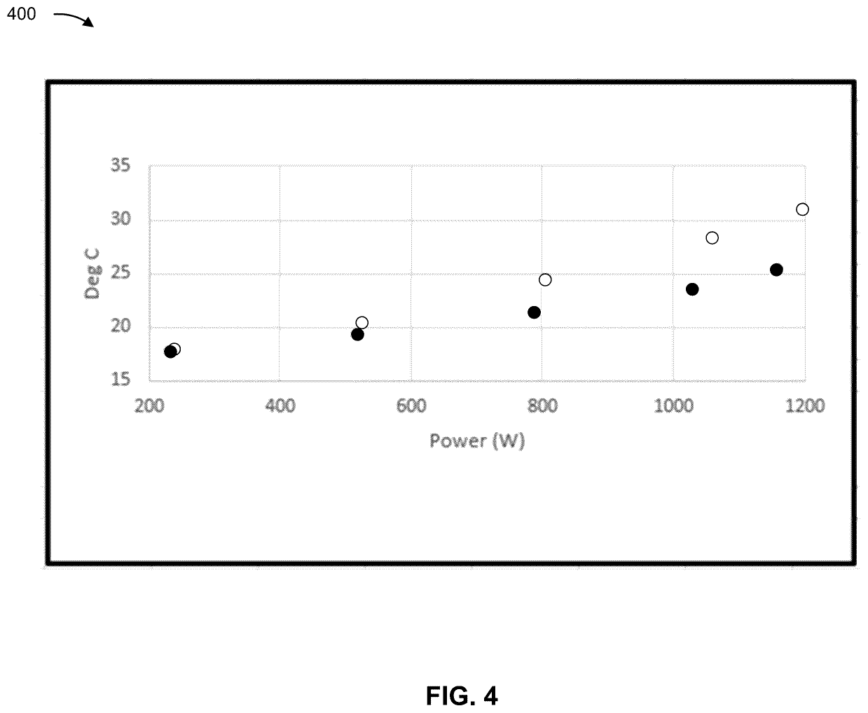

FIG. 4 shows an example plot 400 associated with a temperature (in degrees Celsius (C)) of the coating 116 (e.g., at a “strip edge” of the coating 116) in relation to a power (in watts (W)) of cladding light propagating through the exterior cladding 112 of the optical fiber 108 described herein in relation to FIG. 1A. The unfilled circles show temperatures of the coating 116 for various powers of cladding light when the cladding light stripper 102 described herein is not present. The black-filled dots show temperatures of the coating 116 for various powers of cladding light when the cladding light stripper 102 described herein is present. Accordingly, as shown in FIG. 4, the cladding light stripper 102 can decrease a temperature (e.g., by stripping a high NA portion of the cladding light) of the coating 116 for a particular power (as compared to when the cladding light stripper 102 is not present). In many cases, this can mean a difference between an acceptable heating temperature of the optical fiber 108 and a thermal failure of the optical fiber 108.

FIG. 4 is provided as an example. Other examples may differ from what is described with regard to FIG. 4.

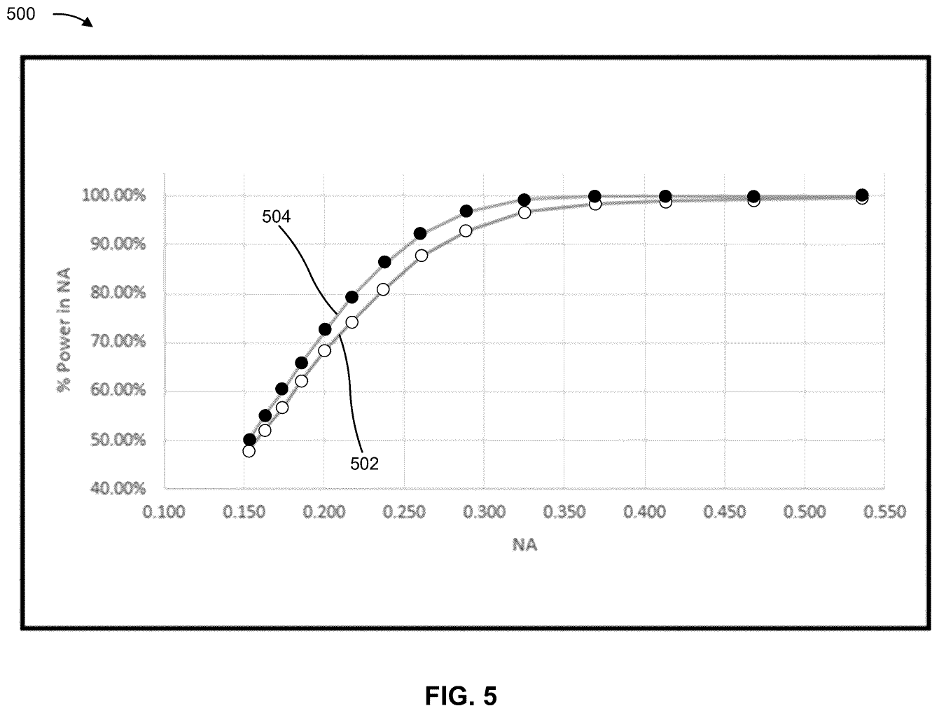

FIG. 5 shows an example plot 500 associated with a percentage of power in NA for an NA of cladding light propagating through the exterior cladding 112 of the optical fiber 108 described herein in relation to FIG. 1A. The unfilled circles and the corresponding curve 502 show a significant portion (e.g., greater than 1%) of power in a “high NA” portion of the cladding light (e.g., for cladding with NA greater than or equal to 0.350) when the cladding light stripper 102 described herein is not present. In contrast, the black-filled circles and the corresponding curve 504 show less than a significant portion (e.g., less than or equal to 1%) of power in a high NA portion of the cladding light (e.g., for cladding with NA greater than or equal to 0.350) when the cladding light stripper 102 described herein is present. In this way, plot 500 shows that the cladding light stripper 102 reduces an amount of the high NA portion of the cladding light (as compared to when the cladding light stripper 102 is not present). Accordingly, the cladding light stripper 102 reduces the amount of light potentially heating and/or damaging the coating 116.

FIG. 5 is provided as an example. Other examples may differ from what is described with regard to FIG. 5.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A cladding light stripper, comprising:
a light removal component, wherein:
the light removal component is configured to contact a first circumferential region of an exterior surface of an exterior cladding of an optical fiber,
wherein a coating covers the exterior surface of the exterior cladding of the optical fiber and does not cover the first circumferential region,
the light removal component comprises a material that has an index of refraction that is greater than or equal to an index of refraction of the exterior cladding of the optical fiber, and
the light removal component has a shape that enables the light removal component to be disposed, when in contact with the first circumferential region of the exterior surface of the exterior cladding, over a partial circumference of the first circumferential region of the exterior surface of the exterior cladding.

2. The cladding light stripper of claim 1, wherein the exterior cladding is configured to propagate cladding light, wherein:
the cladding light has a numerical aperture (NA) distribution,
a portion of the cladding light is associated with NAs that are greater than a maximum selected NA for the cladding light, and
the light removal component is configured to remove greater than a threshold percentage of the portion of the cladding light as the cladding light propagates through a section of the exterior cladding that is associated with the first circumferential region of the exterior surface of the exterior cladding.

3. The cladding light stripper of claim 1, wherein the exterior cladding is configured to propagate cladding light, wherein:
the cladding light has a numerical aperture (NA) distribution,
a portion of the cladding light is associated with NAs that are less than or equal to a maximum selected NA for the cladding light, and
the light removal component is configured to remove less than a threshold percentage of the portion of the cladding light as the cladding light propagates through a section of the exterior cladding that is associated with the first circumferential region of the exterior surface of the exterior cladding.

4. The cladding light stripper of claim 1, wherein the material of the light removal component includes at least one of:
quartz;
fused silica; or
doped fused silica.

5. The cladding light stripper of claim 1, wherein the cladding light stripper further comprises a heat dissipation element that is disposed on the light removal component.

6. The cladding light stripper of claim 1, wherein the shape of the light removal component is:
planar, or
u-shaped.

7. The cladding light stripper of claim 1, wherein the optical fiber is an input fiber or an output fiber of a pump combiner.

8. The cladding light stripper of claim 1, wherein the first circumferential region of the exterior surface of the exterior cladding of the optical fiber is associated with at least one of:
a splice of the optical fiber,
a taper of the optical fiber, or
a bend of the optical fiber.

9. A cladding light stripper, comprising:
one or more light removal components, wherein:
a light removal component, of the one or more light removal components, is configured to contact a circumferential region of an exterior surface of an exterior cladding of an optical fiber,
the light removal component comprises a material that has an index of refraction that is greater than or equal to an index of refraction of the exterior cladding of the optical fiber, and
the light removal component is configured to be disposed, when in contact with the circumferential region of the exterior surface of the exterior cladding, over a partial circumference of the circumferential region of the exterior surface of the exterior cladding.

10. The cladding light stripper of claim 9, wherein the one or more light removal components include a first light removal component and a second light removal component, wherein:
the first light removal component is configured to contact a first portion of the circumferential region of the exterior surface of the exterior cladding of the optical fiber;
the second light removal component is configured to contact a second portion of the circumferential region of the exterior surface of the exterior cladding of the optical fiber; and
the first portion of the circumferential region of the exterior surface of the exterior cladding of the optical fiber and the second portion of the circumferential region of the exterior surface of the exterior cladding of the optical fiber overlap.

11. The cladding light stripper of claim 9, wherein the one or more light removal components include a first light removal component and a second light removal component, wherein:
the first light removal component is configured to contact a first circumferential region of the exterior surface of the exterior cladding of the optical fiber;
the second light removal component is configured to contact a second circumferential region of the exterior surface of the exterior cladding of the optical fiber; and
the first circumferential region of the exterior surface of the exterior cladding of the optical fiber and the second circumferential region of the exterior surface of the exterior cladding of the optical fiber do not overlap.

12. The cladding light stripper of claim 9, wherein the exterior cladding is configured to propagate cladding light, wherein:
the cladding light has a numerical aperture (NA) distribution,
a portion of the cladding light is associated with NAs that are greater than a maximum selected NA for the cladding light, and
a particular light removal component, of the one or more light removal components, is configured to remove greater than a threshold percentage of the portion of the cladding light as the cladding light propagates through the exterior cladding.

13. The cladding light stripper of claim 9, wherein the exterior cladding is configured to propagate cladding light, wherein:
the cladding light has a numerical aperture (NA) distribution,
a portion of the cladding light is associated with NAs that are less than or equal to a maximum selected NA for the cladding light, and
a particular light removal component, of the one or more light removal components, is configured to remove less than a threshold percentage of the portion of the cladding light as the cladding light propagates through the exterior cladding.

14. The cladding light stripper of claim 9, wherein a shape of each light removal component of the one or more light removal components is:
planar, or
u-shaped.

15. The cladding light stripper of claim 9, wherein the material of each light removal component of the one or more light removal components includes at least one of:
quartz;
fused silica; or
doped fused silica.

16. A cladding light stripper, comprising:
a light removal component, wherein:
the light removal component is configured to contact a circumferential region of an exterior surface of an exterior cladding of each optical fiber of a plurality of optical fibers,
the light removal component comprises a material that has an index of refraction that is greater than or equal to an index of refraction of the exterior cladding of each optical fiber, and
the light removal component is configured to be disposed, when in contact with the circumferential region of the exterior surface of the exterior cladding of each optical fiber, over a partial circumference of the circumferential region of the exterior surface of the exterior cladding of each optical fiber.

17. The cladding light stripper of claim 16, wherein the exterior cladding of each optical fiber is configured to propagate cladding light, wherein:
a portion of the cladding light is associated with NAs that are greater than a maximum selected NA for the cladding light, and
the light removal component is configured to remove greater than a threshold percentage of the portion of the cladding light as the cladding light propagates through the exterior cladding of the optical fiber.

18. The cladding light stripper of claim 16, wherein the exterior cladding of each optical fiber is configured to propagate cladding light, wherein:
a portion of the cladding light is associated with NAs that are less than or equal to a maximum selected NA for the cladding light, and
the light removal component is configured to configured to remove less than a threshold percentage of the portion of the cladding light as the cladding light propagates through the exterior cladding of the optical fiber.

19. The cladding light stripper of claim 16, wherein respective portions of the light removal component are associated with the plurality of optical fibers, and a shape of each portion of the light removal component is:
planar, or
u-shaped.

20. The cladding light stripper of claim 16, wherein the material of the light removal component includes at least one of:
quartz;
fused silica; or
doped fused silica.
